(19) United States
(12) Patent Application Publication
(10) Pub. No.: US 2024/0308257 A1
(43) Pub. Date: Sep. 19, 2024

(54) Count Enabled Stamp Application Device And Method Of Use

(71) Applicant: Nelida Montes De Oca, Granite Falls, WA (US)

(72) Inventor: Nelida Montes De Oca, Granite Falls, WA (US)

(21) Appl. No.: 18/122,518

(22) Filed: Mar. 16, 2023

(51) Int. Cl. B41K 1/36

(52) U.S. Cl. CPC B41K 1/366

(57) ABSTRACT

A stamp application device for maintaining a count of stamps applied includes a rubber stamp, a display, and a sensor. The rubber stamp comprises a shell having a bottom that is open. A die is slidably attached to the shell and extends from its bottom. The shell can be grasped in a hand of a user to position the die on a surface and to apply a force to the die causing a flow of ink from the die to apply a stamp. The sensor is attached to a lower end of a housing, which is attached by its upper end to the shell. The sensor detects contact of the die, which corresponds with a stamping event. The sensor sends a signal corresponding to the stamping event to the display, which presents a count of the number of stamping events.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### Field of the Invention

The disclosure relates to stamp application devices and more particularly pertains to a new stamp application device for maintaining a count of stamps applied. The present invention discloses a stamp application device that maintains a count of stamping events and which can log a date and time for each stamping event.

### Description of Related Art Including Information Disclosed Under 37 CFR 1.97 and 1.98.

The prior art relates to stamp application devices, which may comprise pre-inked rubber stamps with counters reliant upon magnets and magnetic field sensors or having document imaging camera, and self-inking rubber stamps with counters. What is lacking in the prior art is a count enabled stamp application device having a logging function for recording a time and date of each stamping event.

### BRIEF SUMMARY OF THE INVENTION

An embodiment of the disclosure meets the needs presented above by generally comprising a rubber stamp, a display, and a sensor. The rubber stamp comprises a shell, which defines an interior space and which has a bottom that is open. A die is slidably attached to the shell, is positioned in the interior space, and extends from the bottom of the shell. The shell is configured to be grasped in a hand of a user, enabling the user to position the die on a surface and to apply a force to the die, via the shell, causing a flow of ink from the die so that a stamp is applied to the surface. A housing is positioned in the interior space and is attach by its upper end to a top of the shell. The sensor is attached to a lower end of the housing and is configured to detect contact of the die upon sliding of the die into the shell, which corresponds with a stamping event. The display is attached to an exterior face of the shell. The sensor is operationally engaged to the display and is enabled to send a signal corresponding to the stamping event to the display. The display is configured to present a count of the number of stamping events.

Another embodiment of the invention includes a method of obtaining a count a number of stamps applied comprises a provision step, which entails providing count enabled stamp application device according to the disclosure above. A first operational step of the method is grasping the shell. A second operational step is positioning the die on a surface to be stamped. A third operational step of the method is applying a force to the die, via the shell, so that the die applies a stamp to the surface. An observational step of the method is observing the count of the number of stamping events on the display.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an in-use view of a count enabled stamp application device according to an embodiment of the disclosure.

FIG. 2 is a top view of an embodiment of the disclosure.

FIG. 3 is a front view of an embodiment of the disclosure.

FIG. 4 is a side view of an embodiment of the disclosure.

FIG. 5 is a block diagram of an embodiment of the disclosure.

FIG. 6 is an isometric perspective view of an embodiment of the disclosure.

FIG. 7 is a flow diagram for a method utilizing an embodiment of the disclosure.

### DETAILED DESCRIPTION OF THE INVENTION

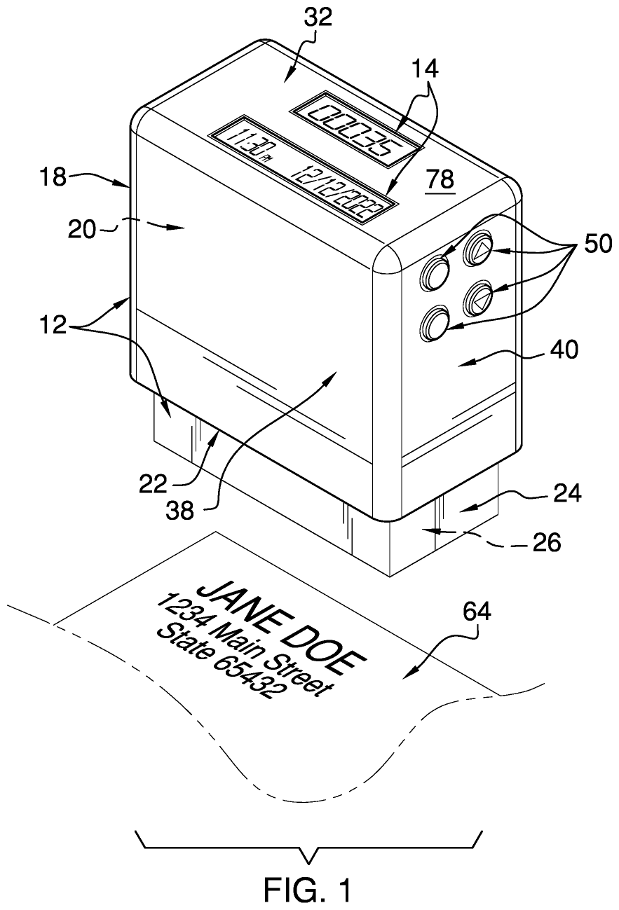

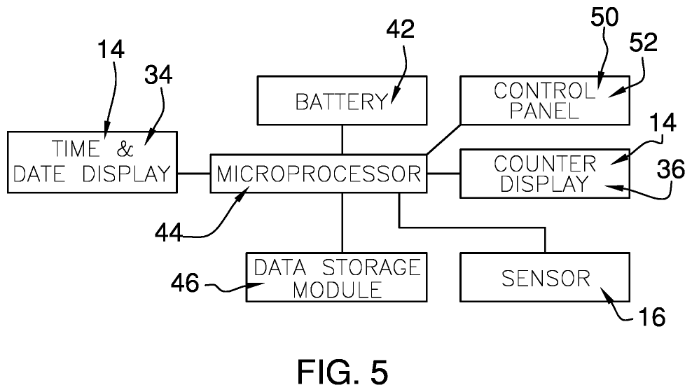

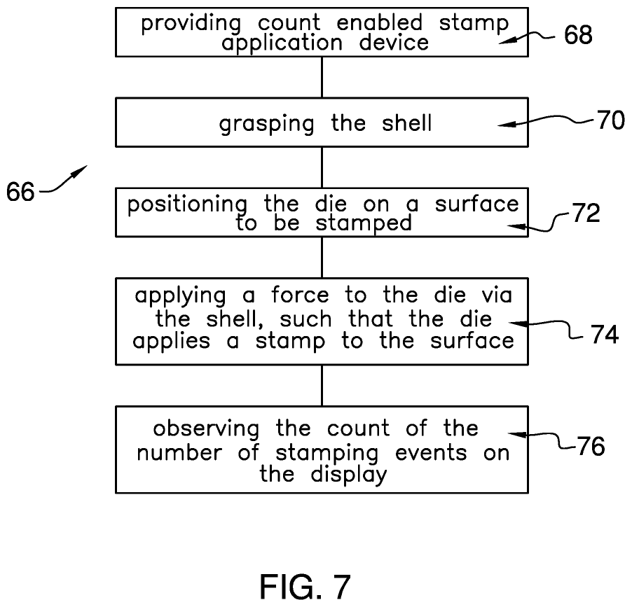

With reference now to the drawings, and in particular to FIGS. 1 through 7 thereof, a new count enabled stamp application device embodying the principles and concepts of an embodiment of the disclosure and generally designated by the reference numeral 10 will be described.

As best illustrated in FIGS. 1 through 7, the count enabled stamp application device 10 generally comprises a rubber stamp 12, a display 14, and a sensor 16. The rubber stamp 12 comprises a shell 18, which defines an interior space 20 and which has a bottom 22 that is open. A die 24 is slidably attached to the shell 18, is positioned in the interior space 20, and extends from the bottom 22 of the shell 18. The die 24 may be rectangular, circular, oval, or the like.

The shell 18 is configured to be grasped in a hand of a user, enabling the user to position the die 24 on a surface 64 and to apply a force to the die 24, via the shell 18, causing a flow of ink 26 from the die 24 so that a stamp is applied to the surface 64. In addition to the die 24 being pre-inked, as described here, the present invention also anticipates the rubber stamp 12 comprising a self-inking stamp.

A housing 28 is positioned in the interior space 20 and is attach by its upper end 30 to a top 32 of the shell 18. The sensor 16 is attached to a lower end 80 of the housing 28 and is configured to detect contact of the die 24 upon sliding of the die 24 into the shell 18, which corresponds with a stamping event. Such sensors are known to those skilled in the art of detectors and include, but are not limited to, contact sensors, proximity sensors, and the like. Additionally, the sensor 16 may comprise motion sensors, cogwheels, and the like.

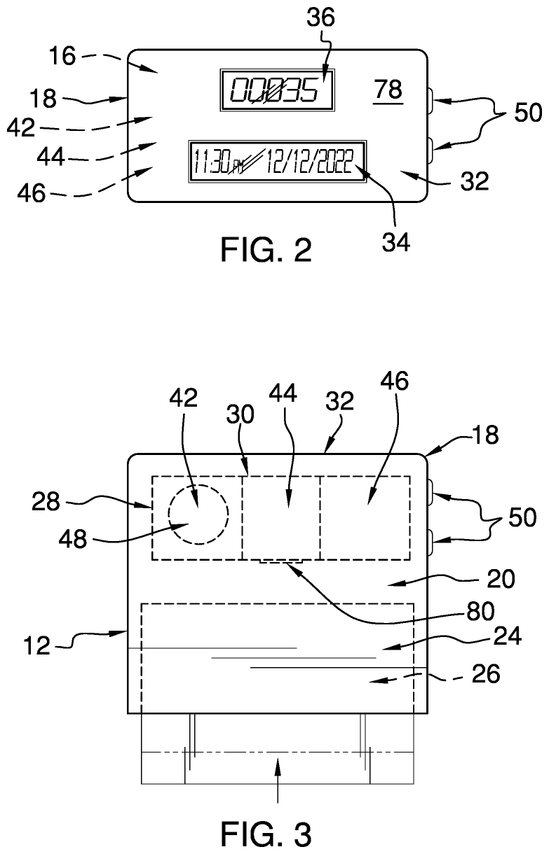

The display 14 is attached to an exterior face 78 of the shell 18. The sensor 16 is operationally engaged to the display 14 and is enabled to send a signal corresponding to the stamping event to the display 14. The display 14 is configured to present a count of the number of stamping events. As shown in FIG. 2, a first portion 34 of the display 14 presents a time and a date, with the count of the number of stamping events being presented on a second portion 36 of the display 14. The first portion 34 and the second portion 36 of the display 14 may be positioned on the top 32 of the shell 18, or alternatively positioned, such as on a respective opposed side 38 or a respective opposed end 40 of the shell 18.

A battery 42, a microprocessor 44, and a data storage module 46 are attached to the housing 28 and are positioned in an internal space 48 defined by the housing 28. The microprocessor 44 is operationally engaged to the battery 42, the display 14, the sensor 16, and the data storage module 46. The microprocessor 44 is enabled to receive the signal from the sensor 16 for each stamping event and to actuate the display 14 to present the count of the number of stamping events. The microprocessor 44 also is enabled to actuate the data storage module 46 to store a date and a time corresponding to each stamping event.

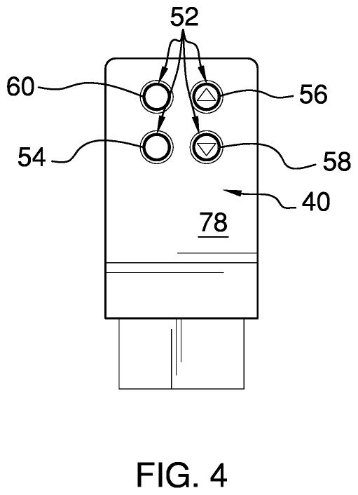

A control panel 50 is attached to the shell 18 and is operationally engaged to the microprocessor 44. The control panel 50 is configured to be manipulated by a user for one or more of setting a time, setting a date, and adjusting a count of the number of stamping events. For example, the count may be reset to zero at the start of a new date or at the beginning of an event. As shown in FIG. 4, the control panel 50 may comprise a plurality of depressible buttons 52, for example, a selection button 54 for selecting the date, time, or count, and an Up Button 56 and a Down Button 58 for adjusting the selected parameter, along with a Power Button 60. Also as shown in FIG. 4, the control panel 50 may be positioned on a respective opposed end 40 of the shell 18.

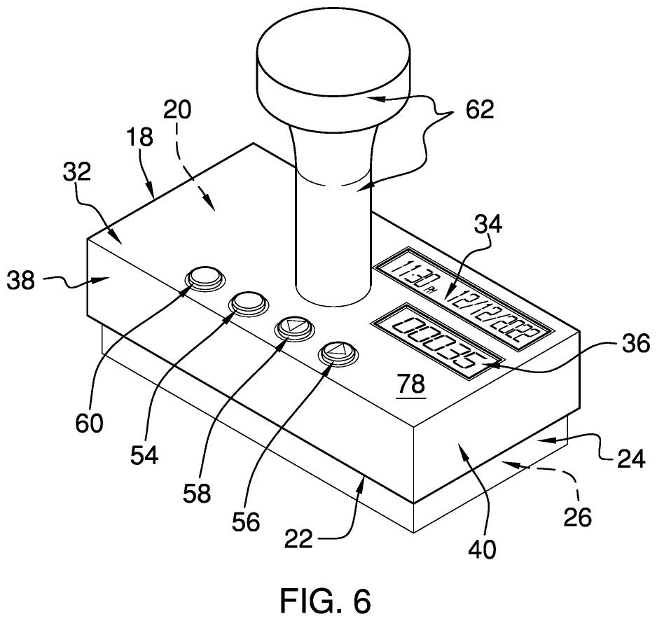

A handle 62 may be attached to and extend from the top 32 of the shell 18, as shown in FIG. 6. The handle 62 is configured to be grasped in the hand of the user, enabling the user to position the die 24 on the surface 64 and to apply the force to the die 24, via the shell 18, thus causing the flow of ink 26 from the die 24 so that the stamp is applied to the surface 64. As shown in FIG. 6, the display 14 and the control panel 50 may be positioned on the top 32 of the shell 18 along with the handle 62.

In use, the count enabled stamp application device 10 enables a method of obtaining a count a number of stamps applied 66 comprises a provision step 68, which entails providing a count enabled stamp application device 10 according to the specification above. A first operational step 70 of the method 66 is grasping the shell 18. A second operational step 72 is positioning the die 24 on a surface 64 to be stamped. A third operational step 74 of the method 66 is applying a force to the die 24, via the shell 18, so that the die 24 applies a stamp to the surface 64. An observational step 76 of the method 66 is observing the count of the number of stamping events on the display 14. The present invention is anticipated to be of use in a variety of situations, such as in counting and logging use of a rubber stamp 12 imparting a stamped signature. Another use of the count enabled stamp application device 10 could be stamping of hands, as is performed commonly when entering various events, which would facilitate compliance with occupancy limits for a structure, such as a bar, concert venue, or the like.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A count enabled stamp application device comprising:
a rubber stamp comprising:
a shell defining an interior space, a bottom of the shell being open, and
a die slidably attached to the shell, positioned in the interior space, and extending from the bottom of the shell, wherein the shell is configured for grasping in a hand of a user, enabling the user for positioning the die on a surface and applying a force to the die via the shell causing a flow of ink from the die, such that a stamp is applied to the surface;
a display attached to an exterior face of the shell;
a housing positioned in the interior space, an upper end of the housing being attached to a top of the shell; and
a sensor attached to a lower end of the housing wherein the sensor is positioned to be contacted by movement of the die into the shell when the force is applied to the die via the shell, the sensor being configured for detecting contact of the die upon sliding of the die into the shell, the sensor being operationally engaged to the display and enabled for sending a signal corresponding to a stamping event to the display, wherein the display is configured for presenting a count of the number of stamping events.

2. The count enabled stamp application device of claim 1, wherein the die is rectangular, circular, or oval.

3. The count enabled stamp application device of claim 1, further including:
a first portion of the display presenting a time and a date; and
the count of the number of stamping events being presented on a second portion of the display.

4. The count enabled stamp application device of claim 1, further including:
a battery attached to the housing and positioned in an internal space defined by the housing; and
a microprocessor attached to the shell, positioned in the internal space, and operationally engaged to the battery, the display, and the sensor, such that the microprocessor is enabled for receiving a signal from the sensor for each stamping event and for actuating the display for presenting the count of the number of stamping events.

5. The count enabled stamp application device of claim 1, further including a control panel attached to the shell and operationally engaged to the microprocessor, wherein the control panel is configured for being manipulated by a user for one or more of setting a time, setting a date, and adjusting a count of the number of stamping events.

6. The count enabled stamp application device of claim 1, further including a data storage module attached to the housing, positioned in the internal space, and operationally engaged to the microprocessor, such that the microprocessor is enabled for storing a date and a time corresponding to each stamping event.

7. The count enabled stamp application device of claim 1, further including a handle attached to and extending from the top of the shell, wherein the handle is configured for grasping in the hand of the user, enabling the user for positioning the die on the surface and for apply the force to the die via the shell causing the flow of ink from the die, such that the stamp is applied to the surface.

8. A count enabled stamp application device comprising:
a rubber stamp comprising:
a shell defining an interior space, a bottom of the shell being open, and
a die slidably attached to the shell, positioned in the interior space, and extending from the bottom of the shell, wherein the shell is configured for grasping in a hand of a user, enabling the user for positioning the die on a surface and applying a force to the die via the shell causing a flow of ink from the die, such that a stamp is applied to the surface, the die being rectangular, circular, or oval;
a display attached to an exterior face of the shell, a first portion of the display presenting a time and a date;
a housing positioned in the interior space, an upper end of the housing being attached to a top of the shell;
a sensor attached to a lower end of the housing wherein the sensor is positioned to be contacted by movement of the die into the shell when the force is applied to the die via the shell, the sensor being configured for detecting contact of the die upon sliding of the die into the shell, the sensor being operationally engaged to the display and enabled for sending a signal corresponding to a stamping event to the display, wherein the display is configured for presenting a count of the number of stamping events, the count of the number of stamping events being presented on a second portion of the display;
a battery attached to the housing and positioned in an internal space defined by the housing;
a microprocessor attached to the shell, positioned in the internal space, and operationally engaged to the battery, the display, and the sensor, such that the microprocessor is enabled for receiving a signal from the sensor for each stamping event and for actuating the display for presenting the count of the number of stamping events;
a control panel attached to the shell and operationally engaged to the microprocessor, wherein the control panel is configured for being manipulated by a user for one or more of setting a time, setting a date, and adjusting a count of the number of stamping events; and
a data storage module attached to the housing, positioned in the internal space, and operationally engaged to the microprocessor, such that the microprocessor is enabled for storing a date and a time corresponding to each stamping event.

9. The count enabled stamp application device of claim 8, further including a handle attached to and extending from the top of the shell, wherein the handle is configured for grasping in the hand of the user, enabling the user for positioning the die on the surface and for apply the force to the die via the shell causing the flow of ink from the die, such that the stamp is applied to the surface.

10. A method of obtaining a count a number of stamps applied using a count enabled stamp application device, the method comprising the steps of:
providing count enabled stamp application device comprising:
a rubber stamp comprising:
a shell defining an interior space, a bottom of the shell being open, and
a die slidably attached to the shell, positioned in the interior space, and extending from the bottom of the shell, wherein the shell is configured for grasping in a hand of a user, enabling the user for positioning the die on a surface and applying a force to the die via the shell causing a flow of ink from the die, such that a stamp is applied to the surface,
a display attached to an exterior face of the shell,
a housing positioned in the interior space, an upper end of the housing being attached to a top of the shell, and
a sensor attached to a lower end of the housing wherein the sensor is positioned to be contacted by movement of the die into the shell when the force is applied to the die via the shell, the sensor being configured for detecting contact of the die upon sliding of the die into the shell, the sensor being operationally engaged to the display and enabled for sending a signal corresponding to a stamping event to the display, wherein the display is configured for presenting a count of the number of stamping events;
grasping the shell;
positioning the die on a surface to be stamped;
applying a force to the die via the shell, such that the die applies a stamp to the surface; and
observing the count of the number of stamping events on the display.

11. The method of claim 10, further including:
a battery attached to the housing and positioned in an internal space defined by the housing;
a microprocessor attached to the shell, positioned in the internal space, and operationally engaged to the battery, the display, and the sensor, such that the microprocessor is enabled for receiving a signal from the sensor for each stamping event and for actuating the display for presenting the count of the number of stamping events;
a control panel attached to the shell and operationally engaged to the microprocessor, wherein the control panel is configured for being manipulated by a user for one or more of setting a time, setting a date, and adjusting a count of the number of stamping events; and
a data storage module attached to the housing, positioned in the internal space, and operationally engaged to the microprocessor, such that the microprocessor is enabled for storing a date and a time corresponding to each stamping event.
